(19) United States
(12) Patent Application Publication
(10) Pub. No.: US 2002/0150077 A1
(43) Pub. Date: Oct. 17, 2002

(54) Data transmission method

(76) Inventor: Miodrag Temerinac, Gundelfingen (DE)

Correspondence Address: Samuels, Gauthier & Stevens LLP, Suite 3300, 225 Franklin Street, Boston, MA, 02110, US

(21) Appl. No.: 09/917,398

(22) Filed: Jul. 27, 2001

(30) Foreign Application Priority Data
Jul. 29, 2000 (EP) 00 11 6465.6

(51) Int. Cl. H04J 3/06; H04J 3/22

(52) U.S. Cl. 370/349; 370/468

(57) ABSTRACT

A data transmission method for a packet-like data format with a control section and a following data section. When transmitting the packet-like data format, the data rate is switched between the control section and the data section by a control instruction transmitted in the control section. This increases the data rate for the data section in comparison to the data rate of the control section.

### BACKGROUND OF THE INVENTION

The present invention relates to the field of communications, and in particular to a data transmission technique that employs a first data rate to transmit packet header information and a second data rate to transmit packet data.

Packet formats generally begin with a synchronization section, to synchronize the transmitter and receiver with clock pulses. Then comes an address section to identify the receiver and possibly also the transmitter. This is followed by a control section with control data that relate to control and verification instructions in the receiver and which also contain information about the transmitted data. These format sections at the beginning of the packet or after the synchronization section are typically globally referred to as a “Header”. The header is then followed by the data section of the packet, which contains the transmitted data and is relatively long compared to the header and/or the synchronization section. A packet end information section that indicates the end of the data packet is necessary if the length of the format is not fixed and cannot be recognized from the information in the control section for the receiver.

Exchange of data is becoming more and more important, because audio, video and other information, for example, books, journals, maps, photos, scanned documents, etc., are appearing more and more as data in digital form. There is an increasing need to take along, store, or share with others the associated data instead of the actual information, over a wireless communication channel.

The worldwide “Bluetooth” transmission standard is an example of such a data transmission technique that employs a packet-like data format. Devices employing “Bluetooth” technology can transmit data by radio over short distances, which eliminates the need for cable connections to mobile communication equipment such as handys, laptops, etc., and other electronic devices. For example, such a radio transmission path can replace the cable connection between a computer and its associated mouse. The worldwide unlicensed frequency range between 2.4 GHz and 2.48 GHz is used for the Bluetooth transmission standard. This frequency range is freely available for industrial, scientific, and medical purposes. To exclude mutual interference, the maximum permissible transmission power of the Bluetooth transmission standard is drastically limited, because its radio transmission is intended only for a relatively short range. To eliminate interference from industrial or medical sources, the “spread spectrum” process is used, which is relatively insensitive to interfering frequency peaks in the covered frequency spectrum. More details about the Bluetooth transmission standard are described, for example, in “Funkschau”, No. 9, 2000, Apr. 14, 2000, Pages 54 to 57, in the review article by Prof. Dr. Harald Melcher “Bluetooth Transmission”. Detailed information about the Bluetooth standard is found, for example, in the specification, which can be downloaded from the internet address “http://bluetooth.com”: “The Bluetooth Specification”, Version 1.0B of Nov.29, 1999, in Part B “Baseband Specification”, Chapter 4 “Packets”, Pages 47 to 66, and which contains a discussion of the packet-like data format.

Another wireless data-transmission method is disclosed in “Funkschau”, No. 13, of Jun. 9, 2000, Pages 43 to 45, entitled “Multimedia-Capable Data Radio Transmission”. This method is intended to connect devices such as personal computers, printers, video cameras, or TV receivers by wireless transmission through a Digital European Cordless Telecommunication (DECT) radio connection. The intended range of the radio connection is about 50 meters inside buildings and about 300 meters outside.

A disadvantage of these and similar packet-like transmission standards, especially for applications in the entertainment and consumer field, is their relatively slow data transmission rate. In the case of Bluetooth, for example, this slow rate is due to the relatively small channel width of 1 MHz. When transmitting large amounts of data, for instance audio and especially video data, the transmission takes too long. For example, transmitting 3 minutes of MP 3-compressed music, corresponding to approximately 2.8 MByte with a channel-limited data rate of 128 kBit/s, would take about 33 seconds. This is much too long, especially in view of possible interference during this time that may require one or more repetitions of the transmission. This time should be reduced at least by a factor of ten. The advantages of the already existing systems, for example the use of established functional units and of license-free frequency domains, naturally should be retained as much as possible. So as not to compete head on with the already existing systems and, on the other hand, so as to utilize their popularity and advantages, any new transmission method should be as compatible as possible with at least one of these already existing systems.

Therefore, there is a need for a data transmission technique for transmitting data packets with a high data transmission rate, while retaining, as much as possible, compatibility with already existing transmission methods.

### SUMMARY OF THE INVENTION

Briefly, according to an aspect of the present invention, a method of transmitting data over a wireless communication channel from a transmitter to a receiver includes forming a data packet that includes a synchronization field, a header field and a data field. The header field includes an address field comprising address data indicative of the transmitter address, and a control field that comprises a data rate control signal indicative of either a first data transmission rate or a second data transmission rate. The header field is transmitted over the wireless communication channel at the first data transmission rate. An acknowledgement from the receiver is then received indicating that the receiver received the data within the control field and is prepared to receive data at the second data transmission rate. The data field is then transmitted to the receiver at the second data transmission rate, wherein the second data transmission rate is greater than the first data transmission rate.

According to a second aspect of the present invention, a method of receiving a data packet that includes a header field and a data field over a wireless communication channel from a transmitter, includes receiving the data packet header field over the wireless communication channel at first data rate. The data packet header field includes a control field that comprises a data rate control signal indicative of either the first data rate or a second data rate. The receiver checks the status of the data rate control signal and receives the data packet data field at a rate indicated by the data rate control signal.

The basic idea here is that the data, which generally are collected together by symbols, are transmitted at different data rates, such that the long data section is transmitted at a much higher rate than the preceding data of the packet. For this purpose, the control information in the control section of the transmitted data format switches the receiver to reception at a high data rate, such that the bandwidth, transmission type, and possibly processing clock pulse for the following data section is adjusted to the corresponding bandwidth, data rate, and transmission type of the transmitter. If the receiver does not recognize this control information or, for example, if this information has not been sent, the receiver naturally also will not be switched.

The desired compatibility with previous, non-switching receivers or transmitters is achieved by a return message from the receiver to the transmitter, to acknowledge that the receiver has recognized the control information and will switch at the right moment. This corresponds more or less to an extension of the “handshake protocol”, which generally already exists by error messages and other information exchanged in both directions between the transmitter and receiver, so that noisy data packets can be retransmitted. If there is no return message from the receiver acknowledging the instruction to switch to a higher frequency, the transmitter continues to operate at the lower rate.

The transmission method is completely self-sufficient without the function of an acknowledgment of the control information, and then data can be transmitted only to appropriately matched receivers. Regardless of this, these data formats naturally can be essentially identical to already existing data formats. Since the transmission method functions only within the associated transmitter and receiver, the special control information can be omitted entirely, because the transmitter and receiver automatically switch over to the higher data rate before the data section is transmitted.

The higher data rate imposes some requirements both on the transmitter and receiver. For example, either a higher channel bandwidth, because each symbol is time-compressed and thus the symbol period is reduced, whereby the required bandwidth is correspondingly increased, or a higher data rate by increasing the multi-valent symbol coding (i.e., the number of bits per symbol). Finally, these two measures can also be combined to achieve a higher data rate. This is an especially beneficial route, because the available reserves of bandwidth and signal quantity can be distributed better. The change of symbol coding corresponds to a change of modulation type. For example, rather than transmitting only four distinct phases by a simple four-quadrant phase modulation, the number of discrete phases per symbol can be increased, which increases the number of distinct logical states. The symbol rate does not change. Pure phase modulation types are typically referred to as Phase Shift Keying (PSK). Additional symbols can be distinguished if discrete phases are combined with discrete amplitudes. Four-quadrant techniques with different amplitudes are quite widespread here. These techniques are typically referred to as Quadrature Amplitude Modulation (QAM), and 16, 64, or even 256 logical states can be distinguished in this way. The associated QAM modulation types are correspondingly abbreviated as 16 QAM, 64 QAM, and 256 QAM.

Another known technique uses frequency modulation to transmit logical states, for example both Bluetooth and DECT. So that the required bandwidth does not become too large, there is no hard frequency shift keying, but rather soft frequency modulation that follows a Gaussian curve (i.e., “Gaussian Minimum Shift Keying”(GMSK)).

Increasing the multi-valent symbol coding is only possible where there is little noise. However, since the data are only transmitted a short distance in a relatively short time, the chances of noise interference are small. In an extreme case, the site of data transmission will be changed.

With digital filters the receiver can switch bandwidth by changing the processing clock pulse and/or changing the filter coefficients. With analog filters this is more problematical. For high stability and insensitivity to tolerances and external influences, multi-valent symbol codings generally are processed digitally. Of course, the bandwidth and the minimum permissible clock pulse rate must not violate the Nyquist criterion. With currently feasible clock pulse rates up to 40 MHz and more, this does not appear to be a limiting factor for consumer applications.

These and other objects, features and advantages of the present invention will become more apparent in light of the following detailed description of preferred embodiments thereof, as illustrated in the accompanying drawings.

### BRIEF DESCRIPTION OF THE DRAWING

FIG. 1 illustrates a packet format;

FIG. 2 illustrates the relationship between channel bandwidth and modulation type;

FIG. 3 illustrates a frequency diagram of an ideal transmission channel;

FIG. 4 illustrates a frequency diagram of a real transmission channel;

FIG. 5 is a flow chart illustration of transmitter processing steps; and

FIG. 6 is a flow chart illustration of receiver processing steps.

### DETAILED DESCRIPTION OF THE INVENTION

FIG. 1 illustrates the structure of a packet format, which begins at time t1 with a synchronization section 1, and ends at time t4. For compatibility reasons, the packet format preferably follows existing data formats and transmission protocols that are standardized and consequently widespread. The synchronization section 1 serves to synchronize a radio transmitter and receiver connected to one another by radio transmission. The packet also includes a header 2 containing an address section 3 starting at time t2, and a control section 4. The address section 3 identifies the radio receiver, and possibly also the transmitter. The control section 4 contains the usual verification and control data for packet transmission, as well as other information. At time t3, there begins a relatively long data section 5 that contains the actual data being transmitted and which ends at time t4. According to the invention, the transmitter transmits the synchronization section 1 and the header 2 at a relatively slow data rate, which may correspond to an associated transmission standard. The data section 5 is then transmitted at a higher data rate.

The control section 4 contains a control signal, which causes the receiver to switch its reception properties so the data section 5 can be received at a higher data rate. Insertion of this control signal generally requires no change of packet format, even with standardized packet formats, because the control section 4 usually contains some empty instruction fields that are available for additional control signals. This facilitates ensuring that the transmission technique of the present invention is compatible with other transmission techniques. Through a “handshake”process, the transmitter and receiver can coordinate transmit ready and receive ready for an optimal increase of the data rate. Without this acknowledgment, the system operates in the associated transmission standard. That is, if the transmitter does not receive the required acknowledgement (i.e., handshake) from the receiver, the transmitter will transmit the data at a lower rate.

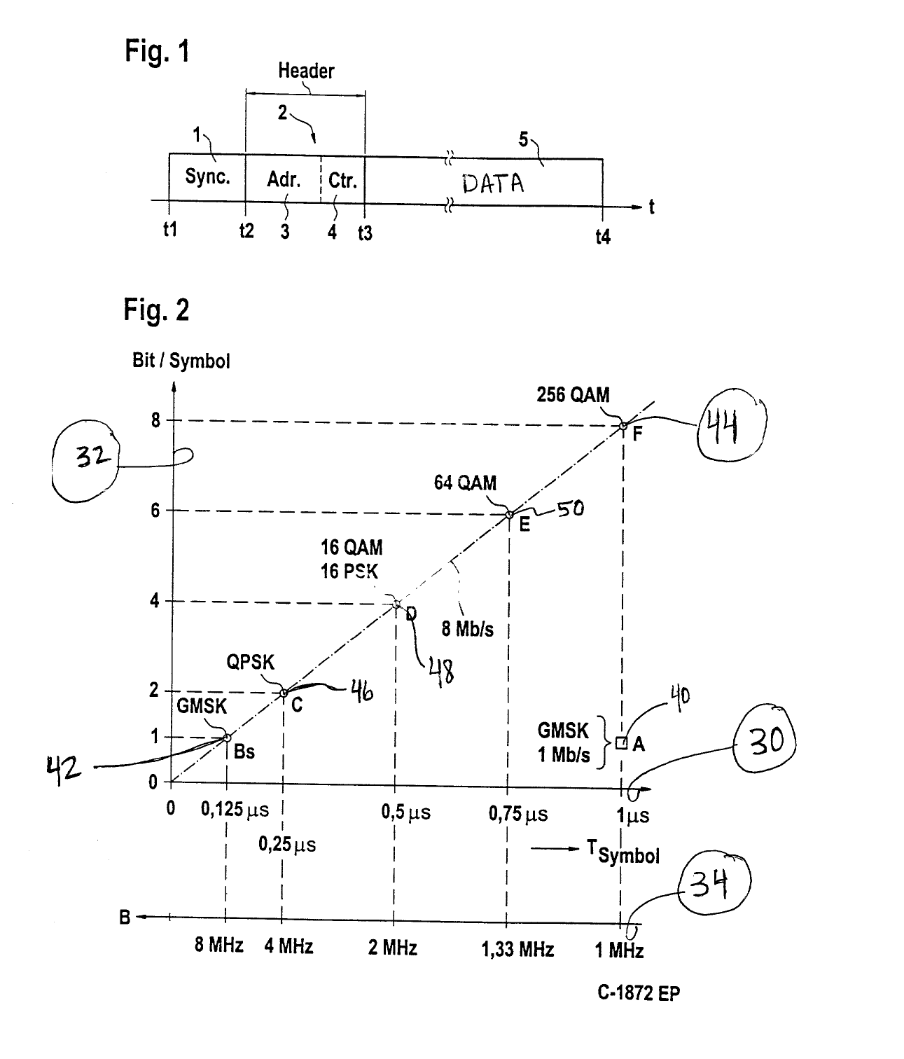

FIG. 2 shows diagrammatically how a change of the channel bandwidth B and of the modulation type can increase the data rate compared to an assumed standard transmission. Time is plotted along horizontal axis 30, and the number of bits per symbol is plotted along vertical axis 32. Bandwidth is plotted along horizontal axis 34. The symbol period and the bandwidth are coupled to one another, so as to use the available frequency ranges as well as possible. As a rule, the bandwidth B in such transmission techniques is only large enough for the particular symbol period T_{symbol} to be transmitted (i.e., if the symbol period is decreased the bandwidth would no longer be sufficient).

Referring to FIG. 2, transmission standard A40 corresponds to the Bluetooth standard, which has a channel bandwidth of 1 MHz and symbols with a symbol period of 1 microsecond. With GMSK, a data rate of 1 Mb/s is transmitted. If the symbol period is decreased to 0.125 microseconds, 8 Mb/s can be transmitted. However, this requires that the available bandwidth B is increased by a factor of eight, to 8 MHz. The diagram of FIG. 2 shows the associated position B42.

If the symbol period of 1 microsecond and thus the bandwidth B of 1 MHz is to be retained, the data rate can be increased by a factor of eight only by increasing the multi-valent symbol coding by a factor of eight. Instead of 1 bit/symbol, as in the transmission standard A40, each symbol now contains eight bits of information such that 256 states per symbol can be distinguished. Referring to FIG. 2, this corresponds to the position F44 with the associated 256 QAM modulation process.

Referring still to FIG. 2, between the possible transmissions according to positions B42 and F44, the transmissions corresponding to positions C46, D48, and E50 are also possible. For example, position C46 represents transmission with a QPSK modulation, position D48 represents transmission with 16 QAM or 16 PSK, and position E50 represents transmission with 64 QAM. The associated number of bits/symbol, channel bandwidth B and symbol period T_{symbol} are readily apparent from the diagram of FIG. 2. For example, positions C, D and E have the following characteristics:

| Position | Bit/Symbol | Channel Width (MH₂) | Symbol Period (μs) |
|---|---|---|---|
| C | 2 | 4 | 0.25 |
| D | 4 | 2 | 0.5 |
| E | 6 | 1.33 | 0.75 |

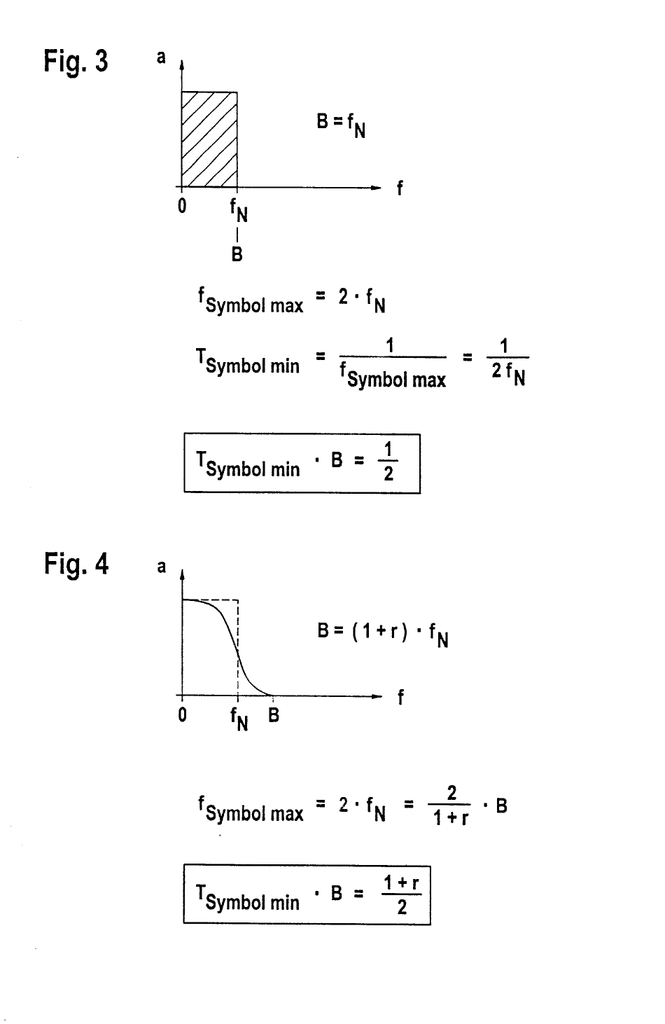

FIG. 3 is a frequency diagram that shows the idealized relationship between a given channel band B and the minimum symbol period T_{symbol min}, which can still be transmitted over this channel. In correspondence with the Nyquist criterion, the signal frequency, which here corresponds to the maximum symbol frequency F_{symbol max}, at most can be half of the Nyquist frequency Fₙ, which in the ideal case is here identical to the bandwidth D of the signal. The ideal signal has a sharply delimited frequency range, which is shown crosshatched in FIG. 3. The following relations can easily be derived for the ideal case:

T_{symbol min}=1/f_{Symbol max}=1/(2f_{N})

T_{Symbol min}×B=½

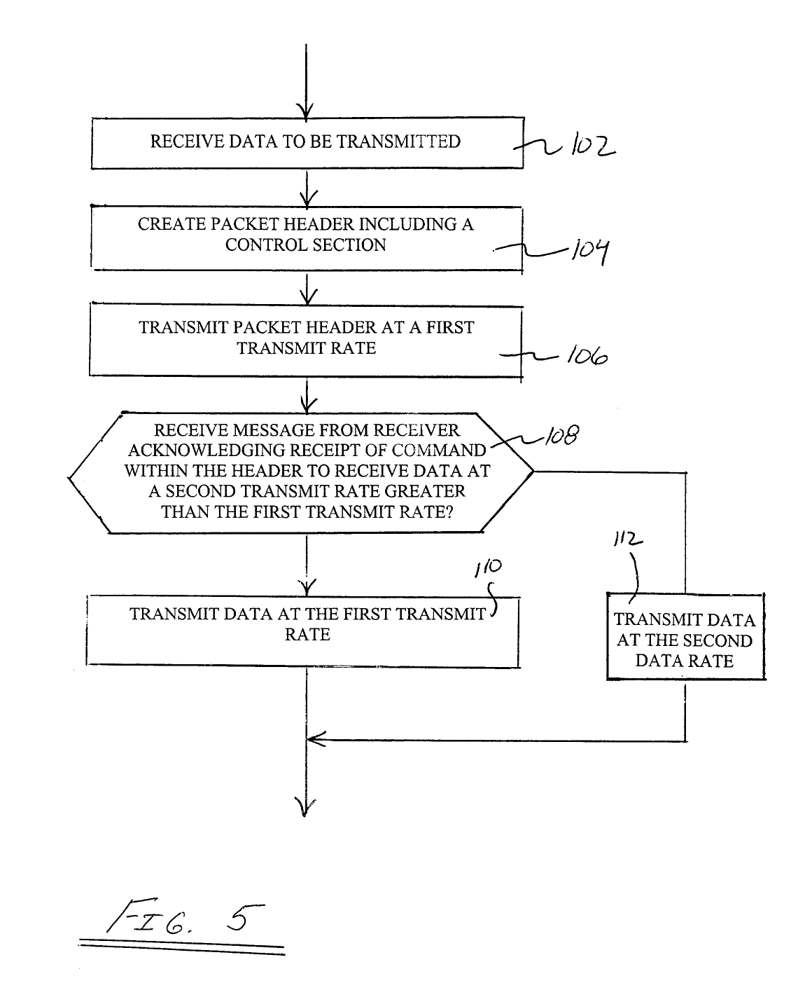

In the real case, such sharp frequency limits fN at most can be approximated, with closer approximation requiring more and more sophistication. Consequently, a compromise is needed between approximation and complexity. With a given symbol period, a frequency response is desired for the transmission channel, which enables transmission with as little additional bandwidth as possible. The real bandwidth B and the associated Nyquist frequency f_{N} will thus differ. FIG. 4 shows this real case. The ideal frequency range up to f_{N} is shown in the frequency diagram by a dashed line, and the real frequency range up to a real band limit B is shown by a solid line. The difference between the ideal and the real frequency limit is specified by a “roll-off” factor “r” as follows:

B=(1+r)F_{N}

With good transmission channels, the roll-off factor r lies between 20% and 60%. With simpler transmission channels, it can easily exceed one. With the roll-off factor r, the relation between the symbol period and the bandwidth, as specified in FIG. 3, changes as specified in FIG. 4:

T_{symbol min}×B=(1+r)/2

It should be mentioned that, for the sake of simplicity, the diagram example of FIG. 2 is based on a roll-off factor of r=1, so that there the simple relation T_{symbol}×B=1 is valid.

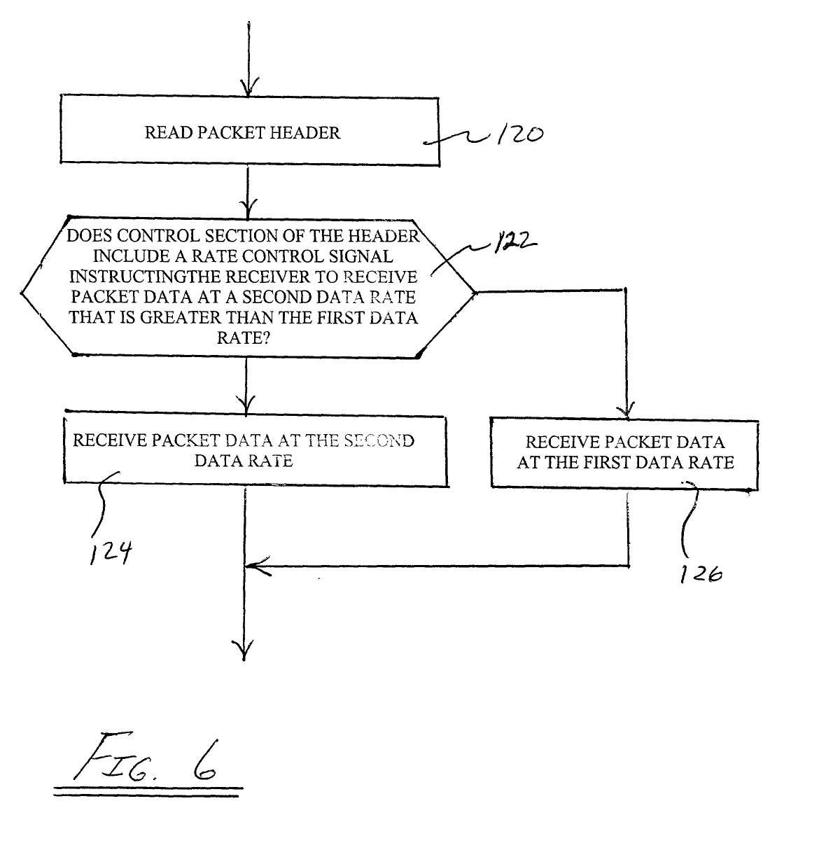

FIG. 5 is a flow chart illustration of the processing according to the present invention performed by a transmitter. In step 102 the transmitter receives data to be transmitted. In step 104 the transmitter creates a packet header that includes a control section. According to an aspect of the present invention, the control section includes instructions for a receiver to receive data at the higher receive rate. In step 106 the transmitter transmits the packet header at a first data rate (that is a relatively low data rate). After a sufficient amount of time has passed for the packet header to be transmitted and for the receiver to acknowledge receipt of the packet header, step 108 is performed to determine whether or not the transmitter has received a message from the receiver acknowledging receipt of the command within the header to receive data at a second transmit rate greater than the first greater rate. If the transmitter does not receive the acknowledgement, step 110 is performed to transmit the information within the data field of the header at the first transmit rate. However, if the transmitter receives the acknowledgement from the receiver, the transmitter transmits data within the data section at the higher second data rate in step 112.

FIG. 6 is a flow chart illustration of the processing performed by a receiver according to an aspect of the present invention. In step 120 the receiver reads the packet header that it has received. In step 122 the receiver performs a test to determine whether or not the control section of the packet header includes a rate control signal instructing the receiver to receive packet data at a second data rate that is greater than the first data rate. If the control section includes such a command, the receiver configures itself to receive subsequent information within the data field at the second data rate in step 124. However, if the control section of the packet header does not include a rate control signal instructing the receiver to receive at the higher rate, step 126 is performed to configure the receiver to receive packet data at the first data rate.

Although the present invention has been shown and described with respect to several preferred embodiments thereof, various changes, omissions and additions to the form and detail thereof, may be made therein, without departing from the spirit and scope of the invention.

What is claimed is:

1. A data transmission method for a packet-like data format, with a control section and a data section, comprising transmitting the control section and the data section of the packet-like data format at different data rates, the data rate of the data section being greater than the data rate of the control section.

2. The data transmission method of claim 1, wherein the control section, situated before the data section, includes a control signal that switches the receiver to a higher data rate for receiving the data of the data section, the higher reception data rate being at least as high as the transmission data rate of the data section.

3. The data transmission method of claim 2, wherein the data rate for transmission and reception is increased by increasing the channel bandwidth (B) and by time-compressing the transmitted data or symbols.

4. The data transmission method of claim 2, wherein the transmission and reception data rate is increased by increasing the multi-valent symbol coding of the transmitted data, while retaining the channel bandwidth (B) and the symbol period (T_{Symbol}).

5. The data transmission method of claim 2, wherein the transmission and reception data rate is increased both by increasing the channel bandwidth (B) with time-compression of the transmitted data or symbols, and by increasing the symbol coding of the transmitted data.

6. A method of transmitting data over a wireless communication channel from a transmitter to a receiver, comprising:
forming a data packet that includes a synchronization field, a header field and a data field, wherein said header field includes
(i) an address field comprising address data indicative of the transmitter address;
(ii) a control field that comprises a data rate control signal indicative of either a first data transmission rate or a second data transmission rate;
transmitting said header field over the wireless communication channel at the first data transmission rate;
receiving an acknowledgement from the receiver indicating that the receiver received the data within the control field and is prepared to receive data at the second data transmission rate; and
transmitting said data field to the receiver at the second data transmission rate, wherein the second data transmission rate is greater than the first data transmission rate.

7. The method of claim 6, wherein said step of transmitting said data field comprises increasing multi-valent symbol coding of data within said data field in comparison to said header field.

8. The method of claim 6, wherein said step of transmitting said data field comprises time compressing data within said data field, and transmitting time compressed data.

9. A method of receiving a data packet that includes a header field and a data field over a wireless communication channel from a transmitter, comprising:
receiving the data packet header field over the wireless communication channel at first data rate, wherein said data packet header field includes a control field that comprises a data rate control signal indicative of either said first data rate or a second data rate;
checking the status of said data rate control signal; and
receiving the data packet data field at a rate indicated by said data rate control signal.

10. The method of claim 9, wherein after said step of checking said method comprises sending an acknowledgement message to the transmitter over the wireless data channel.

11. The method of claim 10, wherein said step of receiving the data packet data field comprises receiving the data packet data field at a second data rate which is greater than the first data rate.
